(19) United States
(12) Patent Application Publication
(10) Pub. No.: US 2011/0312359 A1
(43) Pub. Date: Dec. 22, 2011

(54) Energy Savings For Multi-Point Transmission Wireless Network

(75) Inventors: Troels E. Kolding, Klarup (DK); Frank Frederiksen, Klarup (DK)

(73) Assignee: Nokia Siemens Networks Oy

(21) Appl. No.: 12/817,408

(22) Filed: Jun. 17, 2010

(51) Int. Cl. H04W 74/02

(52) U.S. Cl. 455/509

(57) ABSTRACT

The operational mode of individual ones of a plurality of geographically distributed network nodes is dynamically changed in correspondence with geographic location of at least one wireless data user. Wireless data service is adaptively provided to the at least one data user via at least one of the network nodes whose operational mode is dynamically changed also in correspondence with a data throughput requirement of the at least one data user. The operational mode changes may be switching between an operational diversity transceiving mode, an operational stand-alone transceiving mode, and an idle or off mode. The network nodes may be remote antennas or radio heads. In this manner the operational modes can be switched based on needs and locations of high data throughput users in a cell, and every node that is idle/off represents a power savings.

### TECHNICAL FIELD

The exemplary and non-limiting embodiments of this invention relate generally to wireless communication systems, methods, devices and computer programs and, more specifically, relate to managing communications from various ones of multiple transmit points of a multi-point transmission network such as for example a BTS hotel arrangement for a cellular macro-cell.

### BACKGROUND

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

The following abbreviations that may be found in the specification and/or the drawing figures are defined as follows:
BTS base transceiver system
CO₂ carbon dioxide
CoMP coordinated multi-point
eNB evolved Node-B
H-eNB home eNB
ID identity
RoF radio on/over fiber
RRH remote radio head
RRM radio resource management
UE user equipment

Currently the view for the future of mobile communications generally considers that the increased bandwidth requirements that are reasonably expected will be satisfied by parsing the cells of the currently deployed macro-cell architectures into micro-cells. Two general approaches are seen; micro-radio cells and a BTS hotel architecture. The former is expected to deploy femto, pico and/or micro cells anywhere wireless radio coverage is desired, such as within buildings and tunnels and on street corners and lampposts. In this approach each remote radio head RRH might act as its own BTS constructing a micro-cell and may similarly utilize multiple RRHs to construct a macro cellular structure. Further, multiple micro-cells might fill up coverage area of a general macro-cell. The BTS hotel arrangement is expected to use a single BTS per macro cell with distributed antennas throughout so as to provide discrete coverage of the separate micro-areas. In this early stage of development each approach has certain advantages and disadvantages as compared to the other.

FIG. 1 gives a general overview of the BTS hotel concept. The macro cells 101, 102, 103 are arranged relative to one another similar to common architectures currently in place; each cell is under control of a single BTS and adjacent cells manage interference at the cell edges via cooperative transmission and reception or other interference mitigation techniques. Within one cell 101 there is the controlling BTS 110 and a network of distributed antennas 112, 114, 116, 118 that interface to the BTS via wired connections 113, 115, 117, 119 (for example, copper wire/coaxial cable or fiber optic cable/RoF). Such an arrangement is sometimes termed a CoMP architecture, and is at least partially deployed across select cities such as New York and Seattle.

The potentially large number of remote transceiving nodes in a CoMP architecture has the potential to be operated in an energy inefficient manner. Further and to the extent that other regions of the world adopt a carbon trading scheme along the lines practiced in Europe, it is anticipated that mobile users' use of licensed radio spectrum will be one of several components of an individual's CO₂ invoice. What is needed in the art is a way to operate a CoMP system in manner that is ideally energy efficient from the combined perspective of the network operator and of the mobile user.

### SUMMARY

The foregoing and other problems are overcome, and other advantages are realized, by the use of the exemplary embodiments of this invention.

In a first aspect thereof the exemplary embodiments of this invention provide a method, comprising: dynamically changing operational mode of individual ones of a plurality of geographically distributed network nodes in correspondence with geographic location of at least one wireless data user; and causing wireless data service to be adaptively provided to the at least one data user via at least one of the network nodes whose operational mode is dynamically changed.

In a second aspect thereof the exemplary embodiments of this invention provide a memory storing a program of computer readable instructions, that when executed by at least one processor result in actions comprising: dynamically changing operational mode of individual ones of a plurality of geographically distributed network nodes in correspondence with geographic location of at least one wireless data user; and causing wireless data service to be adaptively provided to the at least one data user via at least one of the network nodes whose operational mode is dynamically changed.

In a third aspect thereof the exemplary embodiments of this invention provide an apparatus, comprising at least one processor and at least one memory storing computer program code. The at least one memory and the computer program code are configured, with the at least one processor, at least to: dynamically change operational mode of individual ones of a plurality of geographically distributed network nodes in correspondence with geographic location of at least one wireless data user; and cause wireless data service to be adaptively provided to the at least one data user via at least one of the network nodes whose operational mode is dynamically changed.

These and other aspects of the invention are detailed with more particularity below.

### BRIEF DESCRIPTION OF THE DRAWINGS

FIG. 1 is a schematic diagram illustrating adjacent macro-cells and detail of one macro cell implemented as a BTS hotel arrangement.

FIGS. 2A-F illustrate schematically an embodiment of the invention in which operational modes of various network nodes in a cell are adjusted dynamically depending on the data needs and positions of user equipments moving in the cell.

FIG. 3 is a logic flow diagram that illustrates, in accordance with an exemplary embodiment of this invention, the operation of a method, and a result of execution of computer program instructions embodied on a computer readable memory.

FIG. 4 shows a simplified block diagram of various electronic devices that are suitable for use in practicing the exemplary embodiments of this invention.

### DETAILED DESCRIPTION

The invention is explained hereinafter by way of examples which are illustrating of but not limiting to the extent of these teachings. That is, while the examples are given as specific embodiments of the invention, the invention is not limited to only these embodiments and is adaptable to many varied environments which may even be dis-similar to those of these examples.

Assume for example there is a network cell in which there is a central BTS and a plurality of network nodes that are geographically distributed throughout the cell and under control of the BTS. That control may be via wired links RoF as in the BTS hotel architecture noted above in which the nodes are then remote antennas, or the control may be via wired or wireless links in which the nodes are RRHs each having at least a transceiver, a processor and an antenna in combination Any one or more of such RRHs may be implemented as a home eNB (H-eNB) in certain implementations. While the H-eNB concept is generally associated with LTE, a H-eNB may operate under any of various wireless technologies, including WiMAX and WCDMA as non-limiting examples. For simplicity of explanation, assume at first that there is one and only one UE operating in the cell, and that this particular UE happens to be utilizing video data services in the cell such as for example wireless broadcast television or some other high volume data. Such a UE can be characterized as a high data throughput user.

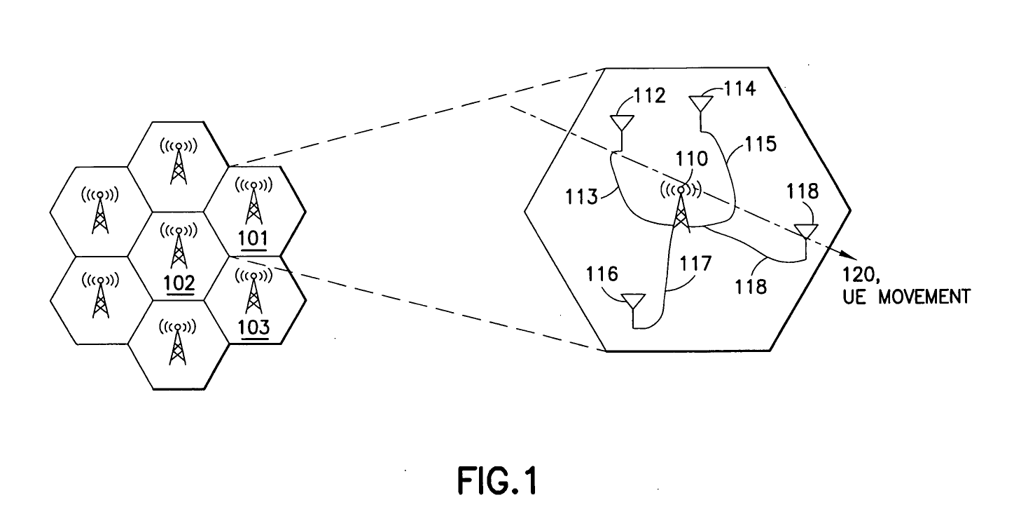

In accordance with an exemplary embodiment of the invention, the network is operated such that the operational mode of individual ones of those network nodes are dynamically changed in correspondence with the geographic location of that wireless high data throughput user. So for example using the layout of the cell at FIG. 1, if the wireless data user moves from the upper left edge of the cell toward the lower right as shown by the arrow 120, and that UE engages in its high throughput data reception throughout, then the BTS controls the nodes such that when the UE is nearest node 112 then node 112 is switched to an operational transceiving mode and all other nodes 114, 116, 118 are switched to an idle or off operational mode. As the UE moves toward the center of the cell, its high throughput data is sent directly by the BTS 110 and so all the remote nodes 112, 114, 116, 118 are in the off or idle operational mode. As the UE moves nearer to node 118 the BTS controls node 118 to switch from the off/idle mode to an operational transceiving mode and all other remote nodes 112, 114, 116 remain in the off/idle mode. Since at least some of the network nodes, 112 and 118 in this example, are actively transmitting data to the UE, then it is clear that the network adaptively provides wireless data service to the UE data user via the network nodes whose operational mode is dynamically changed according to the UE's geographic position or location in the cell.

The above example is a simple implementation which assumes there is one and only one transmitting entity at any given instant from which the single UE receives its high throughout data. The network may choose to employ spatial diversity in its transmissions, so that for example when the UE is nearest node 112 the network controls node 114 to also transmit, enabling the UE to receive a MIMO signal for its broadband wireless service. When the UE is near the BTS 110 the network may provide the high throughput data services from the BTS 110 directly as in the above example, or the network may choose instead that only the nodes remote from the BTS provide the high throughput data services and the BTS is reserved for low data throughput services (for example, voice and SMS/MMS and email messaging) and control signaling.

Regardless of whether or not the BTS 110 provides the high throughput data services, in an exemplary embodiment the low throughput data services are provided throughout the cell by the BTS 110 (and possibly also by one or more conventional relay nodes). The operational mode of the various remote nodes 112, 114, 116, 118 in that case would not be dynamically changed in correspondence with the geographic location of the low data throughput UE, but only the high data throughput UE. In such an implementation then the operational mode is dynamically changed in correspondence with geographic location of the data user and further in correspondence with the data throughput requirement of that user. So for example the network may choose to characterize UEs using a certain type of data, for example video, as high throughput users for purposes of deciding whether to dynamically switch operational modes of the remote nodes, or the network may use some data throughput threshold value for distinguishing the high throughput data users from the low throughput data users. In this manner the network can implement these teachings only for the high data throughput users in the cell and use the BTS 110 and its conventional relay nodes (if any) in the cell for the low data throughput users.

The network need not know the physical location of the UE in order to dynamically control the various remote nodes in correspondence to the UE's geographic location; the network can simply measure received signal strength at various remote nodes 112, 114, 11, 118 and triangulate and/or interpolate the approximate position within the cell and operate the remote nodes accordingly. The network may also measure certain parameters from which it can estimate the UE's location. As one non-limiting example the network can calculate propagation delay from a timing delay with the UE that the network measures itself, and estimate UE location based on that propagation delay. Or the network can receive from the UE its explicit position information or reports of the UE's received signal strength and conclude the UE's position within the cell for operating the remote nodes 112, 114, 116, 118.

The above examples are in the context of a single UE operating in the cell. In practice it is assumed there will typically be a plurality of UEs operating in the cell, some of which are high throughput data users and some of which are low throughput data users. For these more typical conditions, in an embodiment the network simply tracks the multiple UE locations individually and operates the remote nodes dynamically based on the population of high data throughput UEs moving through the cell.

The above embodiments provide the technical effect of a coordinated radio resource management RRM system that utilizes low load on the network, particularly low for the case of a BTS hotel architecture, to provide instantaneous power saving while ensuring very fast responsiveness and coverage for users in need of the high data throughput services. The power savings flow from the remote nodes which being switched to an idle or off mode for the times at which they are not needed for the high throughput data.

The dynamic switching of operational modes of these remote nodes results in dynamic cell definitions, and in the spatial diversity example above it also results in coverage through macro diversity combining. In effect, the number of active remote nodes in the network is reduced when the traffic load is low, and correspondingly, the number of active remote nodes is higher when the load in the cell increases. In an embodiment, the threshold for switching on or off any individual remote node 112, 114, 116, 118 is set to achieve a balance between the overall energy consumption of the network and the traffic load offered by/supported by the cell. This is different from the conventional wireless network configuration in which the power consumption by the network typically scales directly to the number of installed nodes in the system, since conventionally all those nodes remain on and powered. It is observed that even for the situation where some nodes are powered off, it is essential that the network provides basic coverage for initial access and requests for initiating sessions for UE initiated traffic as well as being able to serve UEs with traffic originating from the network side. This is achieved by implementing a network-wide coverage requirement, where basic functionality is assured, while still being able to provide extended data rates in limited geographical areas.

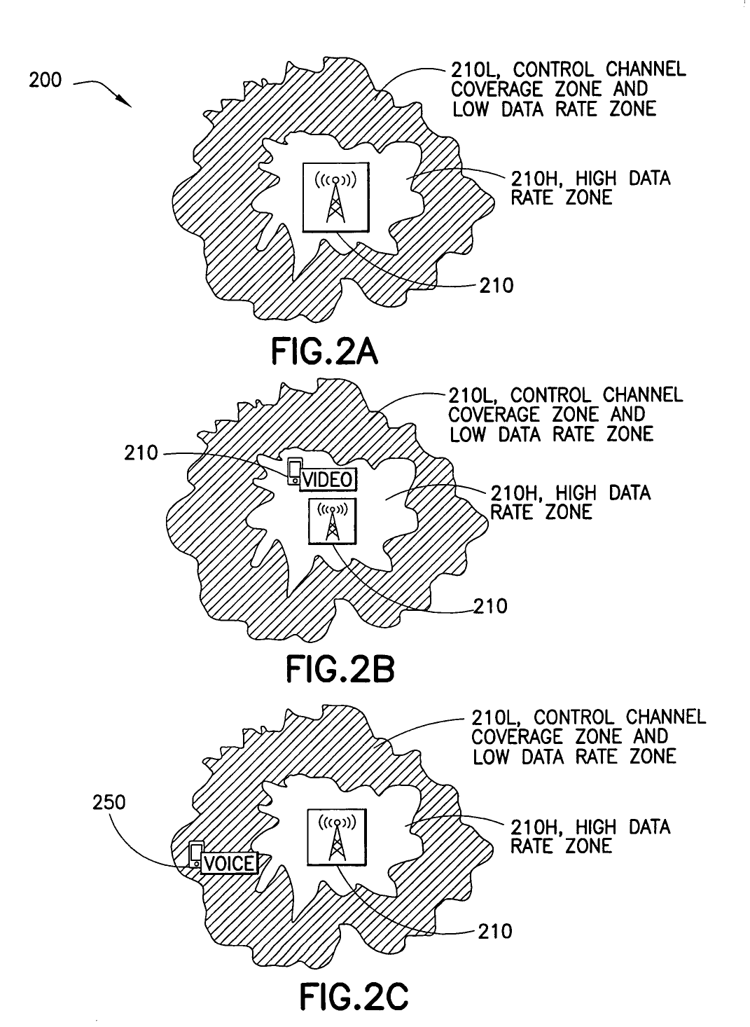

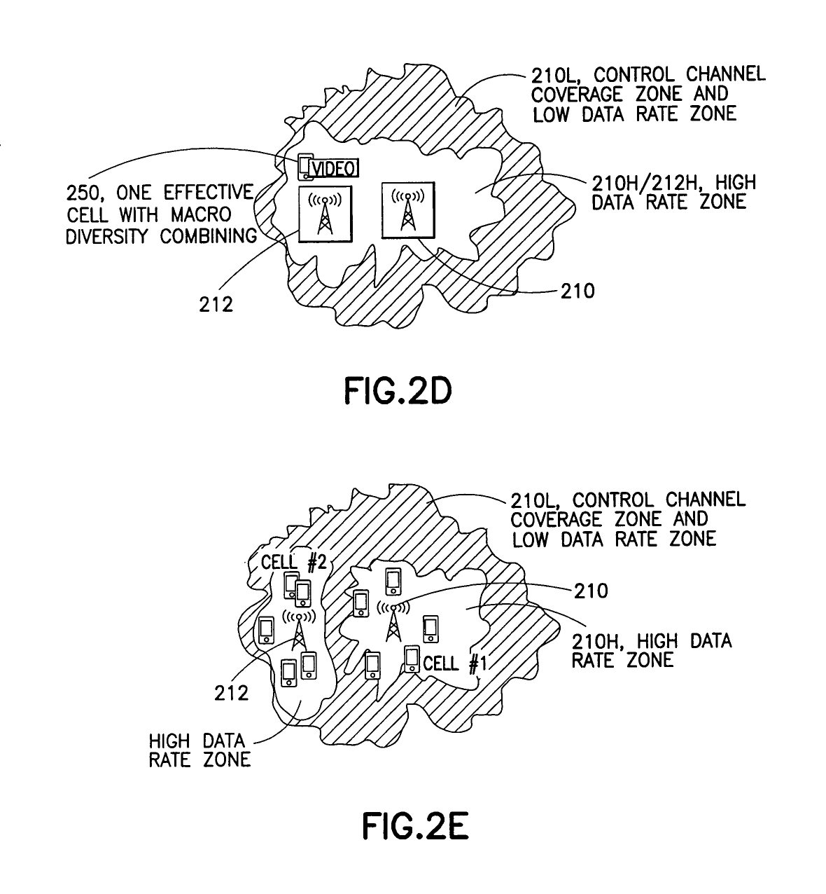

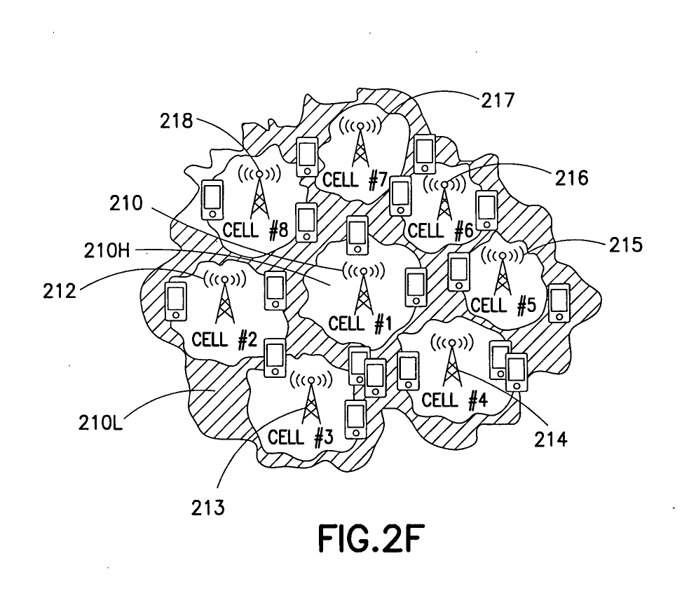

FIGS. 2A-F illustrate for a single network cell how particular exemplary embodiments of the invention might be implemented under various conditions of users, their positions, and their traffic demands. Generally, progressing from FIG. 2A toward FIG. 2F is a progression from minimal or idle network utilization toward full utilization.

At FIG. 2A there are no UEs present and the network cell 200 may be considered to be in an idle mode. There is a control channel coverage area 210L, which is significantly larger than the coverage area for the high data rate region 210H. As in an example above, the low data rate region might be commensurate with the control channel coverage area 210L, as for example would generally be the case if the controlling BTS 210 itself handles all control channel as well as all the low data throughput transmissions (with some minor variance to the areas due to different transmit power on the control versus low throughput data channels). This configuration will typically be caused by switching off a number of the remote nodes (which by example may be H-eNBs but not shown at FIG. 2A) in the system. Since a number of remote nodes in the system are in a non-functional mode (switched to idle or off), the overall energy consumption in the initial coverage area of the system 200 is relatively low.

At FIG. 2B a UE 250 with a video connection (or a typical high data rate application) enters the cell 200, and starts pulling and pushing traffic to and from the network. As the UE 250 is within the high data rate coverage area 210H of the serving node/BTS 210, there is no problem in terms of providing coverage for the UE 250 and no other remote nodes need to be switched out of their idle/off mode.

At FIG. 2C, the UE 250 leaves the high data rate region 210H defined by the cell's serving node 210 and moves into the control channel/low data rate coverage region 210L (or a new UE enters the low data rate coverage region 210L). The network observes this, such as for example by the positioning techniques noted above, and concludes simply that for UE 250 the coverage is low 210L. In this instance the high level RRM algorithm such as that detailed above begins adapting the network behavior to provide sufficient coverage, since the UE 250 is still utilizing the wireless high data throughput video.

In order to provision a high rate of data delivery to the now moved UE 250, increased high-rate coverage in the cell 200 is obtained at FIG. 2D by switching on one or more supporting nodes (diversity nodes), shown at FIG. 2D specifically by switching on one remote node 212. This supporting node 212 (as well as other remote nodes if more than a single supporting node 212 is switched from an idle/off mode to an operational transmitting mode) use the same cell ID as the original serving node 210, thus implementing a distributed antenna system and expanding the high-rate data coverage area of the cell.

The particular implementation at FIG. 2D illustrates the case in which the high data rate area 210H is expanded via turning on the supporting node 212 into one larger area, designated as 210H/212H. As the UE 250 moves through the cell 200, the high data rate area surrounding it moves accordingly, expanding in one direction which the UE 250 is moving toward and shrinking in another direction which the UE 250 is moving from as different supporting nodes are switched between an operational transceiving mode and an idle/off mode. The exact boundaries between high rate coverage areas provided by one node or another are indistinct because adjacent nodes may both be in an operational transceiving mode as shown in FIG. 2D, and because the various nodes, adjacent or not, may in certain exemplary embodiments be simultaneously transmitting and receiving identical data to an individual UE 250 but with spatial diversity. In the case of transmission by the nodes, in an exemplary embodiment the transmitted signals will be combined at one or more UE receive antenna and create the spatial diversity. In case of reception by the nodes, the received signals may be combined at the centralized unit for obtaining the spatial diversity.

A more challenging scenario is where the data demand by the UE (typically by many UEs) in a region of the cell 200 becomes too high for the arrangement shown at FIG. 2D to meet data transmission quality targets (bit error rate, signal to noise ratio, etc). For this situation where the traffic requirements increase in such a way that the single cell operation with distributed antennas/radio heads cannot provide sufficient quality of service, in an embodiment the network adapt by operating in separate cells as shown at FIG. 2E as opposed to the single cell operation shown at FIG. 2D.

At FIG. 2E, the serving cell 210 reverts back to providing high rate data throughout its high rate data area 210H and the supporting node 212 begins providing high rate data throughout its own distinct high rate data area 212H. Each high rate data area 210H, 212H serves separate and distinct UEs as shown at FIG. 2E, and the control channel (and/or low rate data) is provided by the serving node 210 across the whole control channel area 210L regardless of which node 201, 212 provides high rate data to any particular UE.

The operation of changing over from FIG. 2D to FIG. 2E is complex in practice because it entails conversion of diversity nodes into stand-alone cells which results in (a) loss of diversity gain, and (b) the need for handing off traffic to the newly created separate cells. Note that a hybrid of FIGS. 2D and 2E can be employed to mitigate at least some of the diversity loss that would otherwise occur if all nodes were to transmit without diversity. In such a hybrid, some but not all of the supporting nodes operating as a separate cell as shown at FIG. 2E would have their own supporting nodes operating for diversity purposes as in FIG. 2D. Such diversity supporting nodes can be for example those which were previously in an idle or off mode. This transition operation might consist of one node simultaneously acting as a diversity node and as an individual cell in order to provide channel measurements for enabling handover to the newly created independent cell.

FIG. 2F illustrates the case in which the number of high data rate UEs increases even further as compared to FIG. 2E. At FIG. 2F the traffic requirements have increased to the point at which the network adapts even further so that each and every node 210, 212-218 in the cell 200 is operating as an independent cell over its own associated high rate data area 210H and 212H through 218H, respectively. Each such node 210, 212-218 may be considered to define its own cell or sub-cell and each carries their own sets of users. At this point, the network energy consumption will be relative high, but it is to some extent scaled to the amount of traffic carried in the network, such that there is a balance in the overall energy consumption.

Correspondingly, when traffic needs decrease, the network dynamically changes the operational mode from an on/transceiving mode to an idle/off mode for one or more of the various supporting nodes 212-218, passing through the diversity arrangement shown at FIG. 2D while it de-escalates the cell's maximum data capability until reducing the total number of active nodes to reduce energy consumption. Such a de-escalation of the cell's data throughput or rate capacity may be illustrated as the cell configuration moving from FIG. 2F in order back toward FIG. 2A.

According to the above exemplary embodiments, the operational mode of each affected supporting node can be dynamically changed by switching between at least an operational transceiving mode and an idle or off mode as is the case with node 212 being switched on at FIG. 2D as compared to FIG. 2C. Or in another embodiment it can be dynamically changed by switching between at least an operational diversity transceiving mode as in FIG. 2D for node 212 and an operational stand-alone transceiving mode as in FIG. 2E for node 212, as well as the off/idle mode as in FIG. 2C for node 212.

As was noted above, in an exemplary embodiment these teachings may be restricted for only high data throughput users in a cell and not implemented for any users in the cell which are low data throughput users. In various embodiments the geographically distributed network nodes may include a base transceiver station/serving node 210 and a plurality of remote antennas 212-218 coupled to the BTS 210 via wired connections as detailed at FIG. 1, or the remote/supporting nodes 212-218 may be remote radio heads (for example, a combination transceiver and antenna such as for example a home base station H-eNB) under wireless control of the BTS 210.

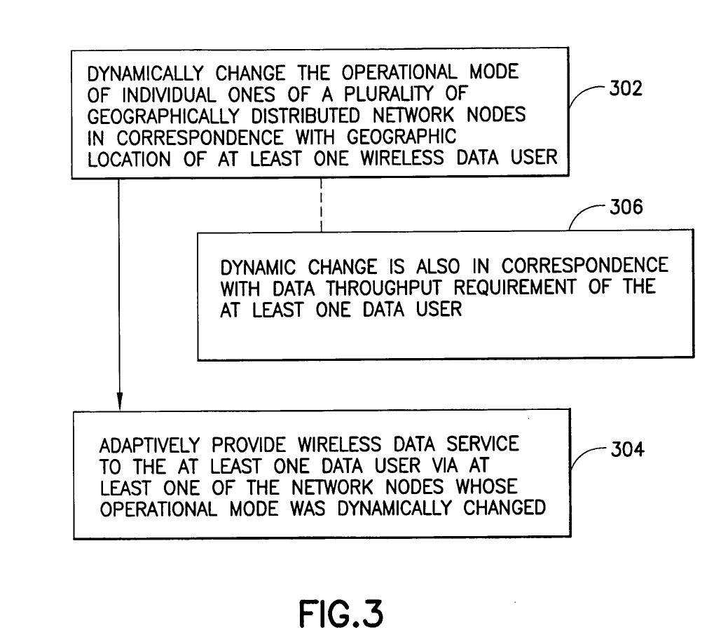

FIG. 3 is a logic flow diagram that illustrates, in accordance with an exemplary embodiment of this invention, the operation of a method, and a result of execution of computer program instructions embodied on a computer readable memory. FIG. 3 is from the perspective of the serving BTS 210 but can be implemented by certain components of a BTS 210 or by some other apparatus that exercises control over switching modes of the various supporting nodes 212-218.

At block 302 such a controlling apparatus dynamically changes the operational mode of individual ones of a plurality of geographically distributed network nodes 212-218 in correspondence with geographic location of at least one wireless data user 250. This is the switching on and off of the affected nodes 212-218. At block 304 the controlling apparatus adaptively provides wireless data service to the at least one data user 250 via at least one of the network nodes 212-218 whose operational mode was dynamically changed. By example this element is implemented by having the nodes 212-218 which were turned on to transmit data to the UE 250 and the nodes which were turned off to discontinue transmitting data to the UE 250.

Optional block 306 makes the dynamic changes to the operational mode in correspondence with data throughput requirement of the at least one data user 250 in addition to the geographic location at block 302. The example above implements this as being that the adaptive operational mode is only applied for the high data users and not for the low data users. As noted above, the operational mode that is dynamically changed (whether based on block 302 with or without block 306 and further with or without additional considerations such as energy optimization) may be implemented by switching between an operational transceiving mode and an idle/off mode, or more specifically between an operational diversity transceiving mode, an operational stand-alone transceiving mode, and an idle/off mode. Other embodiments may include further operational modes for additional granularity in the way the network provides data and balances its activity against energy savings.

For the case in which the remote nodes are private H-eNBs in an LTE system, such H-eNBs operated according to these teachings will be cycled on and off as the data needs arise for individual H-eNBs and so as compared with an always-on alternative these teachings bring down the cost of operating a H-eNB, both in maintenance and more compellingly in the cost of electricity and any CO₂ charges which may be incurred based on data downloaded and/or electricity consumed.

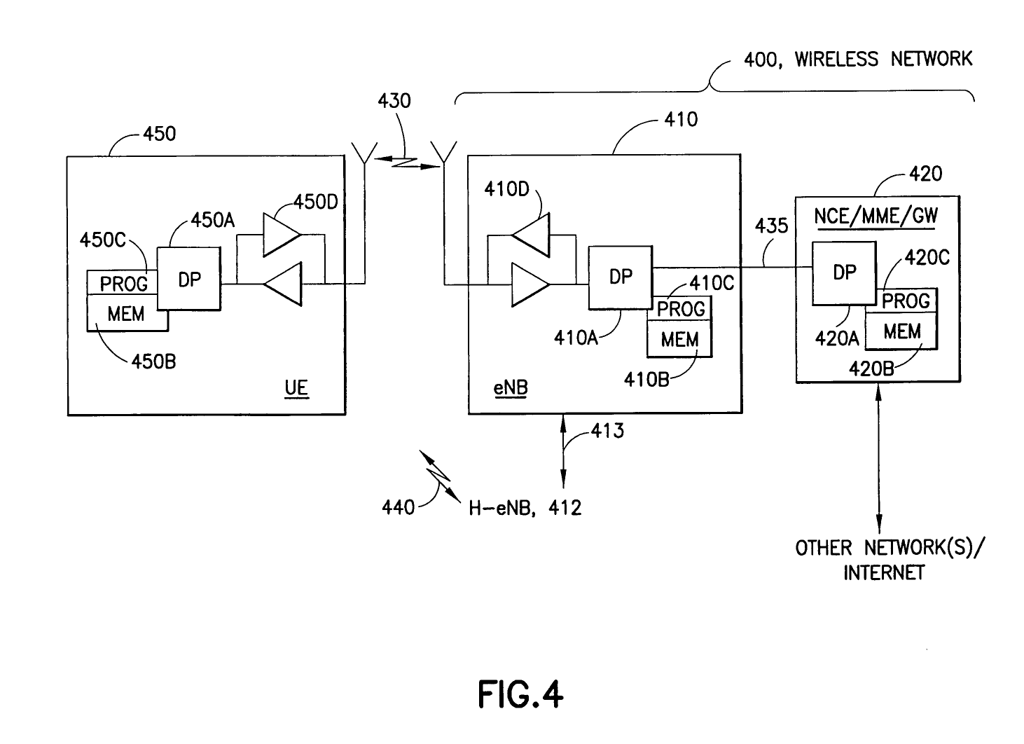

FIG. 4 is a simplified block diagram of various electronic devices and apparatus that are suitable for use in practicing the exemplary embodiments of this invention. In FIG. 4 a wireless network 400 is adapted for communication over a wireless link 430 with an apparatus, such as a mobile communication device such as the UE 450 used in the examples above, via a network access node, such as a Node B (base station), and more specifically a serving eNB 410.

Supporting the serving eNB 400 there is also a plurality of remote nodes of which one is shown at 412. These remote nodes 412 also have a wireless link 440 with the UE 450, active or not depending on the operational mode of the supporting node 412 as switched under control of the serving eNB 410 or other controlling apparatus. As above, the supporting node 412 may be a remote antenna for transmitting and receiving over the link 440 or a separate and distinct remote radio head RRH that includes at least a transceiver and antenna, as well as associated memory and processing hardware to operate. The network 400 may include a network control element (NCE) 420 which provides connectivity with a further network such as a telephone network and/or a data communications network (e.g., the internet).

The serving eNB 410 includes a controller, such as a computer or a data processor (DP) 410A, a computer-readable memory medium embodied as a memory (MEM) 410B that stores a program of computer instructions (PROG) 410C, and a suitable radio frequency (RF) transceiver 410D for bidirectional wireless communications with the UE 450 via one or more antennas. Typically the serving eNB 410 will have an array of antennas though single and multi-antenna implementations are within the scope presented herein. The eNB 410 is coupled via a data/control path 435 such as an S1 interface to the NCE 420. The eNB 410 may also be coupled to the supporting H-eNB 412 via a data/control path 413, which may be implemented as a wired or a wireless interface.

The UE 450 also includes a controller, such as a computer or a data processor (DP) 450A, a computer-readable memory medium embodied as a memory (MEM) 450B that stores a program of computer instructions (PROG) 450C, and a suitable RF transceiver 450D for communication with the eNB 410 via one or more antennas. In general, the various embodiments of the UE 450 can include, but are not limited to, cellular telephones, personal digital assistants (PDAs) having wireless communication capabilities, portable computers (such as laptops, palmtops, tablets and the like) having wireless communication capabilities, music storage and playback appliances having wireless communication capabilities, gaming devices having wireless Internet access for multi-player interactive gaming, and other such portable units or terminals that incorporate combinations of such functions.

At least one of the PROGs 410C in the MEM 410B of the serving eNB 410 or other controlling apparatus is assumed to include program instructions that, when executed by the associated DP 410A, enable the device 410 to operate in accordance with the exemplary embodiments of this invention, such as those detailed above. That is, the exemplary embodiments of this invention may be implemented at least in part by computer software executable by the DP 410A of the eNB 410, or by hardware, or by a combination of software and hardware (and firmware).

The computer readable MEMs 410B and 450B may be of any type suitable to the local technical environment and may be implemented using any suitable data storage technology, such as semiconductor based memory devices, flash memory, magnetic memory devices and systems, optical memory devices and systems, fixed memory and removable memory. The DPs 410A and 450A may be of any type suitable to the local technical environment, and may include one or more of general purpose computers, special purpose computers, microprocessors, digital signal processors (DSPs) and processors based on a multicore processor architecture, as non-limiting examples.

In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the exemplary embodiments of this invention may be illustrated and described as block diagrams, flow charts, or using some other pictorial representation such as those at FIGS. 2A-F and FIG. 3, it is well understood that these blocks, apparatus, systems, techniques or methods described herein may be implemented in, as nonlimiting examples, hardware, software, firmware, special purpose circuits or logic, general purpose hardware or controller or other computing devices, or some combination thereof.

The various blocks shown in FIG. 3 may be viewed as method steps, and/or as operations that result from operation of computer program code, and/or as a plurality of coupled logic circuit elements constructed to carry out the associated function(s). At least some aspects of the exemplary embodiments of the inventions may be practiced in various components such as integrated circuit chips and modules, and that the exemplary embodiments of this invention may be realized in an apparatus that is embodied as an integrated circuit. The integrated circuit, or circuits, may comprise circuitry (as well as possibly firmware) for embodying at least one or more of a data processor or data processors, a digital signal processor or processors, baseband circuitry and radio frequency circuitry that are configurable so as to operate in accordance with the exemplary embodiments of this invention.

Various modifications and adaptations to the foregoing exemplary embodiments of this invention may become apparent to those skilled in the relevant arts in view of the foregoing description, when read in conjunction with the accompanying drawings. However, any and all modifications will still fall within the scope of the non-limiting and exemplary embodiments of this invention.

1. A method, comprising:
an apparatus dynamically changing operational mode of individual ones of a plurality of geographically distributed network nodes in correspondence with geographic location of at least one wireless data user; and
the apparatus causing wireless data service to be adaptively provided to the at least one data user via at least one of the network nodes whose operational mode is dynamically changed.

2. The method according to claim 1, in which dynamically changing the operational mode is in correspondence with geographic location of at least one wireless data user and further in correspondence with a data throughput requirement of the at least one data user.

3. The method according to claim 1, in which dynamically changing the operational mode comprises switching between at least an operational transceiving mode and an idle or off mode.

4. The method according to claim 3, in which dynamically changing the operational mode comprises switching between at least an operational diversity transceiving mode, an operational stand-alone transceiving mode, and an idle or off mode.

5. The method according to claim 1, in which the method is restricted for high data throughput users in a cell and is not implemented for any users in the cell which are low data throughput users.

6. The method according to claim 5, in which all users in the cell which are the low data throughput users are provided wireless services by one or more network nodes which are not subject to having their operational modes dynamically changed in correspondence with geographic location of any wireless data user.

7. The method according to claim 1, in which the plurality of geographically distributed network nodes comprise a base transceiver station and a plurality of remote antennas or radio heads coupled to the base transceiver station via wired or wireless connections.

8. A memory storing a program of computer readable instructions that when executed by at least one processor result in actions comprising:
dynamically changing operational mode of individual ones of a plurality of geographically distributed network nodes in correspondence with geographic location of at least one wireless data user; and
causing wireless data service to be adaptively provided to the at least one data user via at least one of the network nodes whose operational mode is dynamically changed.

9. The memory according to claim 8, in which dynamically changing the operational mode is in correspondence with geographic location of at least one wireless data user and further in correspondence with a data throughput requirement of the at least one data user.

10. The memory according to claim 8, in which dynamically changing the operational mode comprises switching between at least an operational transceiving mode and an idle or off mode.

11. The memory according to claim 10, in which dynamically changing the operational mode comprises switching between at least an operational diversity transceiving mode, an operational stand-alone transceiving mode, and an idle or off mode.

12. The memory according to claim 8, in which the aforesaid actions are restricted for high data throughput users in a cell and are not executed for any users in the cell which are low data throughput users.

13. The memory according to claim 8, in which the plurality of geographically distributed network nodes comprise a base transceiver station and a plurality of remote antennas or radio heads under wired or wireless control of the base transceiver station.

14. An apparatus, comprising:
at least one processor; and
at least one memory storing computer program code;
the at least one memory and the computer program code configured, with the at least one processor, at least to:
dynamically change operational mode of individual ones of a plurality of geographically distributed network nodes in correspondence with geographic location of at least one wireless data user; and
cause wireless data service to be adaptively provided to the at least one data user via at least one of the network nodes whose operational mode is dynamically changed.

15. The apparatus according to claim 14, in which the at least one memory and the computer program code are configured with the at least one processor to dynamically change the operational mode in correspondence with geographic location of at least one wireless data user and further in correspondence with a data throughput requirement of the at least one data user.

16. The apparatus according to claim 14, in which the at least one memory and the computer program code are configured with the at least one processor to dynamically change the operational mode by at least switching between at least an operational transceiving mode and an idle or off mode.

17. The apparatus according to claim 16, in which the at least one memory and the computer program code are configured with the at least one processor to dynamically change the operational mode by at least switching between at least an operational diversity transceiving mode, an operational stand-alone transceiving mode, and an idle or off mode.

18. The apparatus according to claim 14, in which the at least one memory and the computer program code are configured with the at least one processor to dynamically change the operational mode for wireless data services provided to high data throughput users in a cell and not for wireless data services provided to any users in the cell which are low data throughput users.

19. The apparatus according to claim 14, in which the plurality of geographically distributed network nodes comprise a base transceiver station and a plurality of remote antennas coupled to the base transceiver station via wired connections.

20. The apparatus according to claim 14, in which the plurality of geographically distributed network nodes comprise a base transceiver station and a plurality of remote radio heads under wireless control of the base transceiver station.
